(19) United States
(12) Patent Application Publication
(10) Pub. No.: US 2019/0251589 A1
(43) Pub. Date: Aug. 15, 2019

(54) METHOD AND SYSTEM FOR A CENTRALIZED GATEWAY PROCESSING CENTER FOR THE REGISTRATION AND TRANSACTION PROCESSING OF CARD LINKED SERVICES CONNECTED TO DEBIT TRANSACTIONS

(71) Applicant: Steven L. VanFleet, Southport, CT (US)

(72) Inventor: Steven L. VanFleet, Southport, CT (US)

(21) Appl. No.: 16/272,645

(22) Filed: Feb. 11, 2019

Related U.S. Application Data
(60) Provisional application No. 62/710,196, filed on Feb. 12, 2018.

(51) Int. Cl. G06Q 30/02; G06Q 20/26; G06Q 20/38

(52) U.S. Cl. CPC G06Q 30/0215; G06Q 20/387; G06Q 30/0236; G06Q 20/26

(57) ABSTRACT

A method and apparatus for facilitating card linked offers with debit card transactions that provides interconnectivity for a number of US debit networks and a great variety of publisher entities in such a way as to allow each network and entity to have one standardized connection with the gateway. This is realized by having the gateway manage the nuances and differences of the various entities such that such differences are transparent to each entity. The manner in which such different environments are accounted for is the core of the invention's value to all entities involved, due to its' resultant simplification of the required development and ongoing maintenance involved with providing CLO-related services.

### CROSS-REFERENCE TO RELATED APPLICATION(S)

This application claims priority to, and the benefit of, co-pending U.S. Provisional Application 62/710,196 filed Feb. 12, 2018 for all subject matter common to both applications. The disclosure of said provisional application is hereby incorporated by reference in its entirety.

### FIELD OF THE INVENTION

The present invention relates to a method and system for providing card linked services connected to debit card transactions. In particular, the present invention relates to providing a gateway that performs the practical application and operations of a central clearinghouse between debit networks, merchants and publishers of card linked offers (CLO).

### BACKGROUND

The rapidly expanding adoption of card-linked offers in the United States by major publishers of merchant content has highlighted a gap in the current industry support infrastructure. Major “publishers”, including Ebates, Dosh, Groupon to name a few, have made major commitments to moving their merchant offers to a card-linked offer (CLO) delivery mechanism. Other large ancillary players, such as Yelp and Uber have also begun to integrate CLO's into their service models.

These initiatives are made possible by the CLO services offered currently by companies such as MasterCard/Visa/American Express, and as of Q1 2018, Discover (the card “Schemes”), whereby they allow these publishers' cards and merchants to register with their platforms, monitor for when a participating card transacts at a participating merchant, and then deliver the qualifying transaction to the publisher for processing the discount.

Currently, though, a large percentage of purchase transactions in the US cannot be included in the CLO programs, specifically those transactions that flow through the PIN debit networks not affiliated with MasterCard or Visa, of which there are currently eight (Pulse, Star, Nyce, Shazam, Jeannie, Accel, AFFN, CU24). Thus, debit cards are either not eligible to be registered in a program or a confusing messaging must be provided to debit cardholders to explain that the card will not always receive a discount at participating merchants.

The Cardlinx Association and the Debit Networks Association (DNA) have both, working in parallel, attempted to address this challenge for the industry. Mandates for standardization of critical data elements and a draft business requirements definition document have been issued to aid in debit networks considering supporting similar services to those offered by the card Schemes.

In order for debit cards to become a viable alternative for CLO a substantial portion of the purchase transactions performed by debit cards needs to be available to publishers. Given the time and investment needed for each network to build the functionality, and similarly on the part of publishers to integrate with numerous debit networks, a better solution is needed.

In addition to this fundamental infrastructure need for the CLO industry to progress, a number of other emerging services, including 1) paying with loyalty currency (PWL), 2) attaching gift cards directly to a payment card, as well as 3) various initiatives around discounts applied at the SKU/CPG level, all will need similar infrastructures for linking specific cards at specific merchants for the application of the savings/discounts/payments for purchase transactions performed by debit cards. However, these technologies, devices, systems, methodologies, etc., experience some shortcomings.

### SUMMARY

There remains need for a solution for the US Debit Networks and offer publishing companies to efficiently enable the inclusion of all debit cards and their related transactions within the growing card-linked offer market.

The present invention provides for a centralized processing clearinghouse or gateway that enables each of the Debit Networks to establish one standardized interface to the gateway and gain access to a multitude of CLO publishing companies. Likewise the US CLO publishers can establish one standardized interface and gain access to all transactions processed by the US debit networks. The debit networks gain access to the entire publishing community with a minimum of initial development and ongoing effort while the publishers gain access to billions of transactions processed each year on the debit network platforms in an optimal manner.

In order to provide such single point of transparent connectivity for each participant, many functions must be managed and provided for by the gateway besides simply a single point of connection. Such functions include:
BIN file management—the gateway gathers BIN files (card routing tables) from each debit network, consolidates them into one consistent file and makes them available on a timely basis to the publishers.
Secure Card Registration—The gateway provides the publishers with one consistent interface for card registration. The gateway manages the routing of cards to the appropriate debit network's files, secures the card numbers in compliance with industry standards, and manages the card database on an ongoing basis.
Merchant Registration and Database Management—the gateway provides for merchant offer registration for publishers to be able to associate which cardholders are eligible for which merchant offers. This includes the analysis and management of a merchant identification database that will allow the recognition of where a purchase transaction is being performed.
Merchant Validation Test Facility—the gateway provides to publishers an automated method to run and monitor test transactions to validate Merchant identifiers.
Transaction Matching—The gateway provides the information necessary for debit networks to monitor for purchase transactions occurring with participating cards at participating merchants and for forwarding matched transactions to the appropriate publisher.
Qualifying Transaction Delivery—the gateway delivers the matched transactions to the appropriate publisher for scoring and communication to the cardholder.
Cardholder Value Settlement—the gateway offers a settlement facility for publishers to credit earned discounts back to the registered debit card via the debit networks credit processing infrastructures.
Reporting, billing, support services are provided as appropriate for the services provided.

In accordance with one embodiment of the present invention, a method of providing card linked services connected to debit card transactions is provided. The method includes the steps of: registering, via a gateway, a debit card for participation in a card linked offer; registering, via the gateway, a merchant for participation in a card linked offer; matching, via the gateway, a transaction to a card linked offer; and settling, via the gateway, the matched transaction based on the parameters of the card linked offer. As such, the gateway provides a common interface between a merchant, a publisher of a card linked offer, and a debit network to facilitate the establishing and handling of a card linked offer involving a debit card transaction.

In accordance with one aspect of the invention, registering a debit card for participation in a card linked offer involves: maintaining a consolidated file comprising BIN tables from one or more debit networks; providing the consolidated file to a publisher of the card linked offer; receiving a request for registration of a debit card number from the publisher; providing the publisher with a unique token for identifying the debit card number in communications between gateway and publisher; registering the debit card number with a registration platform of appropriate debit network based on the consolidated file; and receiving, from the registration platform, a unique token for identifying the debit card number in communications between the gateway and debit network and indication of registration success. In certain aspects, maintaining a consolidated file comprising BIN tables from one or more debit networks involves filtering out entries for card numbers that are not eligible for participation in the card linked offer. In certain other aspects, the registration platform of the appropriate debit network comprises a distributed registration platform provided to the debit network and configured to interface with the gateway and debit network.

According to another aspect, registering a merchant for participation in a card linked offer involves: receiving merchant registration data including an unique acquirer identification and a unique merchant identification; providing the merchant registration data to an appropriate debit network based on the received merchant registration data; and maintaining a database of received merchant registration data. In certain aspects, the received merchant registration data further includes an indication of one or more debit cards eligible for the card linked offer with the merchant. In other certain aspects, providing the merchant registration data to an appropriate debit network based on the received merchant registration data involves providing the merchant registration to a distributed registration platform provided to the debit network and configured to interface with the gateway and debit network.

According to another aspect, a testing facility is provided. The testing facility is configured to register a test card for a card linked offer; monitor and store transaction activity of registered test cards; and provide publishers access to the stored transaction activity of registered test cards.

According to another aspect, matching a transaction for participation in a card linked offer involves: receiving, from a credit network, transactions details for a transaction that matches a card linked offer; and providing data for the matched transaction to the appropriate publisher for the card linked offer for processing. In certain aspects, the transaction details for a transaction that matches a card linked offer are received from a distributed matching platform provided to the debit network and configured to interface with the gateway and debit network. In certain other aspects, a transaction that matches a card linked offer comprises a transaction at a registered merchant using a registered debit card.

According to another aspect, settling the matched transaction based on the parameters of the card linked offer involves: receiving a credit request from the publisher of the card linked offer based on the matched transaction; providing credit request details to the appropriate debit network; collecting funds for the credit request from the publisher of the card linked offer; and distributing collected funds to the appropriate debit network for refunding to the debit card used in the matched transaction. In certain aspects, the funds collected for the credit request are collected by the publisher of the card linked offer from a registered merchant involved in the matched transaction. In certain other aspects, the credit request details are provided in the credit submission format of the appropriate debit network.

### BRIEF DESCRIPTION OF THE FIGURES

These and other characteristics of the present invention will be more fully understood by reference to the following detailed description in conjunction with the attached drawings, in which:

FIG. 1 is a diagrammatic illustration of a system for providing card linked services connected to debit card transactions in accordance with the aspects of the invention;

FIG. 2 is a diagrammatic illustration of a high-level architecture for devices implementing processes in accordance with the aspects of the invention;

FIG. 3 is a flowchart that depicts a methodology for providing card linked services connected to debit card transactions in accordance with the aspects of the invention;

FIG. 4 is a diagrammatic illustration of a system and processes for card registration in accordance with the aspects of the invention;

FIG. 5 is a diagrammatic illustration of a system and processes for merchant registration in accordance with the aspects of the invention;

FIG. 6 is a diagrammatic illustration of a system and processes for transaction matching in accordance with the aspects of the invention; and

FIG. 7 is a diagrammatic illustration of a system and processes for settling a matched transaction in accordance with the aspects of the invention.

### DETAILED DESCRIPTION

An illustrative embodiment of the present invention provides interconnectivity for a number of US debit networks and a great variety of publisher entities in such a way as to allow each network and entity to have one standardized connection using a gateway. This is realized by the creation of a technological solution enabling the gateway to manage the nuances and differences of the various entities such that such differences are transparent to each entity. The manner in which such different environments are accounted for is an improvement to the heretofore prior state of CLO services prior to the practical application of the present invention, due at least in part to a simplification by provision of the technological solution of the present invention of the required development and ongoing maintenance involved with providing CLO-related services.

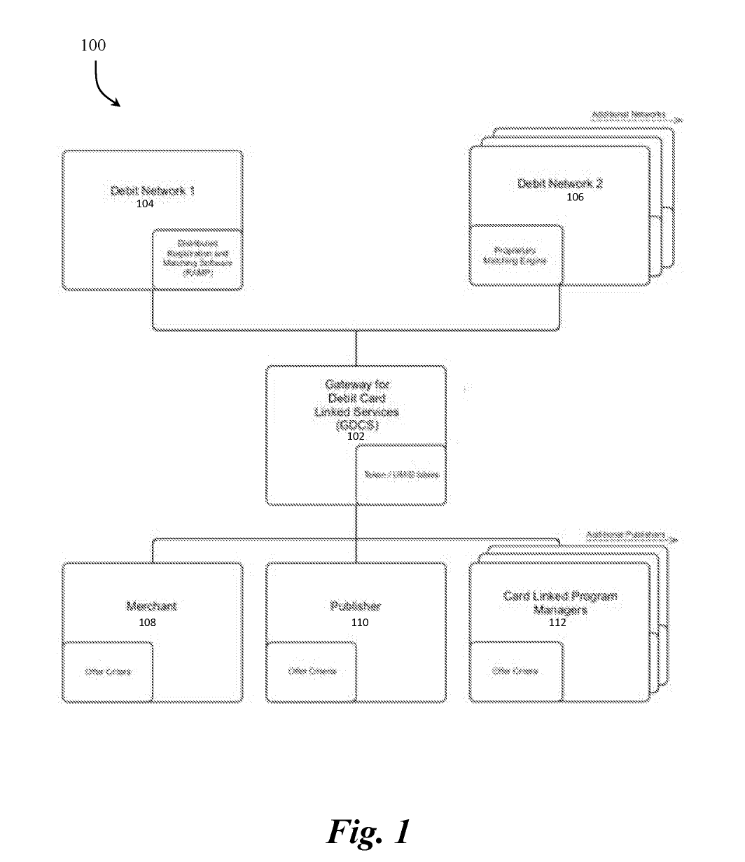

FIG. 1 through FIG. 7 wherein like parts are designated by like reference numerals throughout, illustrate an example embodiment or embodiments of a system and methodology for providing card linked services connected to debit card transactions, according to the present invention. Although the present invention will be described with reference to the example embodiment or embodiments illustrated in the figures, it should be understood that many alternative forms can embody the present invention. One of skill in the art will additionally appreciate different ways to alter the parameters of the embodiment(s) disclosed, such as the size, shape, or type of elements or materials, in a manner still in keeping with the spirit and scope of the present invention.

FIG. 1 depicts an exemplary environment 100 in which the system of the present invention is performed. Here, a gateway 102 for debit card linked services (GDCs) provides the main functionality of the present invention. The gateway 102 provides an interface between a debit network 104, 106 a merchant 108, and a publisher 110.

The gateway 102 can be any type of suitable electronic device capable of being configured to perform the functionality of the present invention. The electronic device gateway 102 is merely an illustrative example of a suitable computing environment and in no way limits the scope of the present invention. The gateway 102 may be a general purpose computer or a specialized computer system. For example, the gateway 102 may include a single computing device, a collection of computing devices in a network computing system, a cloud computing infrastructure, or a combination thereof, as would be appreciated by those of skill in the art. The gateway 102 will be discussed in more detail later in this description.

The debit network 104 can be any one of networks that provide debit card services. Examples of debit networks include but are not limited to: Pulse, Star, Nyce, Shazam, Jeannie, Accel, AFFN, CU24 networks. In certain embodiments, the gateway 102 can also be interfaced with one or more additional debit networks 106. The functionality of the debit networks 104, 106 may be provided by a single computing device, a collection of computing devices in a network computing system, a cloud computing infrastructure, or a combination thereof, as would be appreciated by those of skill in the art.

The merchant 108 can be any entity that sells goods or services. The merchant can be a retail location, such as a department store or restaurant, or an online vendor. The functionality of the merchant may be provided by a single computing device, a collection of computing devices in a network computing system, a cloud computing infrastructure, or a combination thereof, as would be appreciated by those of skill in the art. It should be understood that multiple merchants can be interfaced with gateway 102 as would be apparent to one skilled in the art.

The publisher 110 is the entity that is offering or otherwise providing the Card Linked Offer (CLO). Examples of publishers include, but are not limited to Ebates, Dosh, and Groupon. It should be understood that multiple publishers can be interfaced with gateway 102 as would be apparent to one skilled in the art. In certain embodiments, a card linked program manager 112 may also be interfaced with the gateway 102. The card linked program manager is an entity that manages card linked offers for multiple publishers. The card linked program manager interacts with the gateway in the same way as an individual publisher. As such, the term “publisher” user hereinafter can refer to either a publisher 110 or a card linked program manager 112.

The gateway 102 is interfaced with, connected to, or otherwise in communication with the debit networks 104, the merchant 108 and publisher through a communication network such as the Internet, world wide web, a secure banking network, or equivalents. Suitable communication networks will be apparent to one skilled in the art given the benefit of this disclosure.

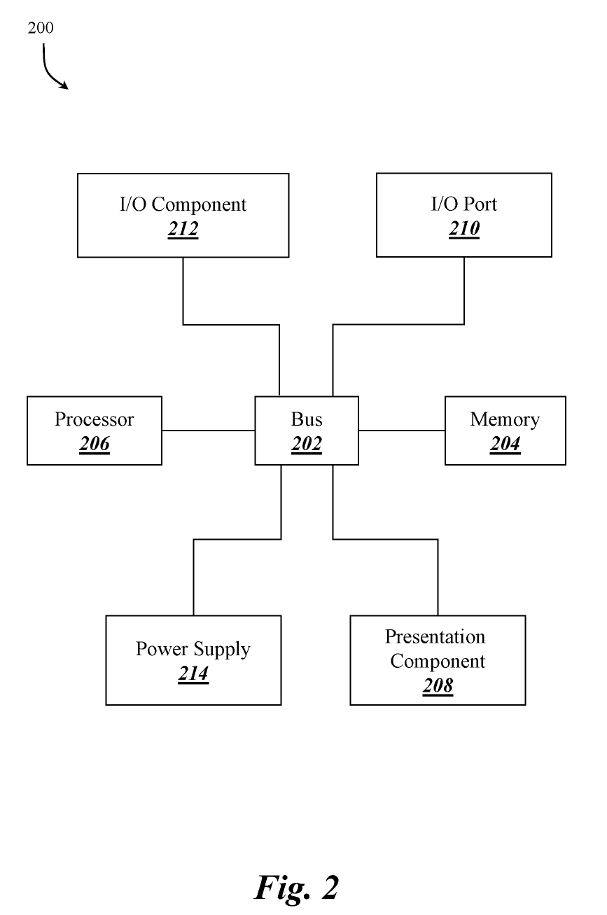

Any suitable computing device can be used to implement the gateway 102 and the methods/functionality described herein. One illustrative example of such a computing device 200 is depicted in FIG. 2. The computing device 200 is merely an illustrative example of a suitable computing environment and in no way limits the scope of the present invention. A “computing device,” as represented by FIG. 2, can include a “workstation,” a “server,” a “laptop,” a “desktop,” or other computing devices, as would be understood by those of skill in the art. Given that the computing device 200 is depicted for illustrative purposes, embodiments of the present invention may utilize any number of computing devices 200 in any number of different ways to implement a single embodiment of the present invention. Accordingly, embodiments of the present invention are not limited to a single computing device 200, as would be appreciated by one with skill in the art, nor are they limited to a single type of implementation or configuration of the example computing device 200.

The computing device 200 can include a bus 202 that can be coupled to one or more of the following illustrative components, directly or indirectly: a memory 204, one or more processors 206, one or more presentation components 208, input/output ports 210, input/output components 212, and a power supply 214.

One of skill in the art will appreciate that the bus 202 can include one or more busses, such as an address bus, a data bus, or any combination thereof. One of skill in the art additionally will appreciate that, depending on the intended applications and uses of a particular embodiment, multiple of these components can be implemented by a single device. Similarly, in some instances, a single component can be implemented by multiple devices. As such, FIG. 2 is merely illustrative of an exemplary computing device that can be used to implement one or more embodiments of the present invention, and in no way limits the invention.

The computing device 200 can include or interact with a variety of computer-readable media. For example, computer-readable media can include Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices that can be used to encode information and can be accessed by the computing device 200.

The memory 204 can include computer-storage media in the form of volatile and/or nonvolatile memory. The memory 204 may be removable, non-removable, or any combination thereof. Exemplary hardware devices are devices such as hard drives, solid-state memory, optical-disc drives, and the like. The computing device 200 can include one or more processors that read data from components such as the memory 204, the various I/O components 212, etc. Presentation component(s) 208 present data indications to a user or other device. Exemplary presentation components include a display device, speaker, printing component, vibrating component, etc.

The I/O ports 208 can enable the computing device 200 to be logically coupled to other devices, such as I/O components 212. Some of the I/O components 212 can be built into the computing device 200. Examples of such I/O components 220 include a microphone, joystick, recording device, game pad, satellite dish, scanner, printer, wireless device, networking device, and the like.

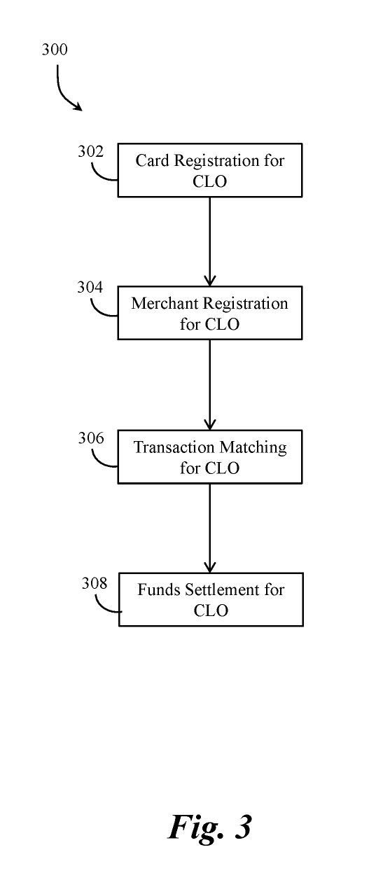

The functionality of the present invention is provided by the system and hardware of FIGS. 1-2 through the execution of software that makes the hardware perform in the desired manner. FIG. 3 depicts flow diagram 300 of one possible implementation of software processes operating on the gateway 102 of FIG. 1 to provide a system that provides card linked services connected to debit card transactions in accordance with aspects of the present invention.

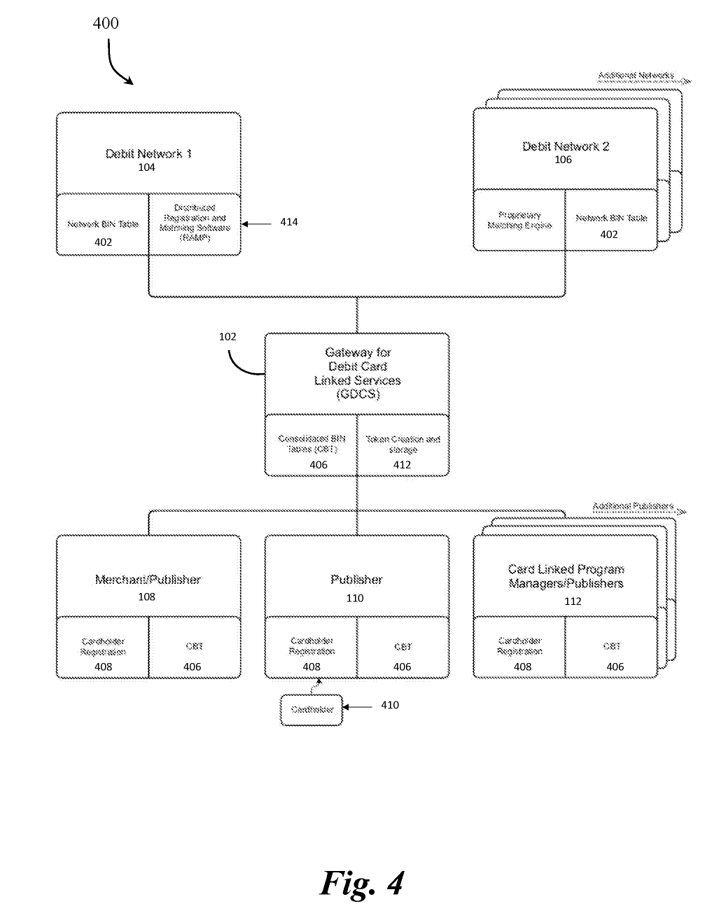

FIG. 3 depicts a flow diagram 300 of the methodology performed by the gateway in accordance with an embodiment. In operation, the gateway 102 performs the step of: registering a debit card for participation in a card linked offer (CLO) 302; registering a merchant for participation in a card linked offer (CLO) 304; matching a transaction to a card linked offer (CLO) 306; and settling the matched transaction based on the parameters of the card linked offer (CLO) 308. Each of these steps will be discussed in more detail below in reference to FIG. 4-FIG. 7.

FIG. 4 sets forth the flow of information and the system of components 400 involved with the registration of debit cards by Merchants 108 and Publishers 110 (including Program Managers 112) in order to enable their eligibility for card linked offer transaction matching and placement of earned rebates on to the card account. This includes: BIN file management and secure card registration.

### BIN File Management

The exemplary system 400 of FIG. 4 performs a series of processes by which the gateway 102 gathers BIN file tables (card routing tables) 402 from each debit network 104, 106, consolidates them into one consistent file 404 and makes them available on a timely basis to the publishers. Each debit network has today a table of BINs (Bank Identifier Numbers) 402 identifying the first digits (typically 6-9) of participating card numbers from financial institutions who utilize the debit network for facilitating purchase transactions performed by the institution's debit cards. The gateway 102 makes use of the existing BIN tables 402. The BIN files and tables 402 vary in form, content and frequency between each network and include types of cards that must be excluded, duplicates between networks that must be accounted for and various idiosyncrasies all of which must be managed so as to produce one consolidated table 406 of eligible debit card BINs made available via an application programming interface (API) or other form of transmission on a regular basis to publishers 110 (or Program Managers 112). Publishers 110 (or Program Managers 112) can use the consolidated table 406 to determine whether a card being registered in their CLO program should be routed to the gateway 102 for registration purposes.

### Secure Card Registration

The exemplary system 400 of FIG. 4 further provides the facilities to allow publishers 110 (or merchants 108 and/or programs managers 112 operating as publishers) to register individual debit cards for eligibility for Card Linked Offers (CLOs). In this embodiment, the publisher 110 (as well as the merchant 108, and program manager 112) provides cardholder registration functionality 408 for the intake of information (e.g. card number, name, address, etc.) from a cardholder 410. Once a card number has been checked against the provided BIN consolidated table 406 to ensure its availability to be registered, the publisher 110 routes the card number via a gateway supplied API, including additional identifying data elements to the gateway 102. The gateway 102 includes token creation and storage functionality 412 that assigns a corresponding proxy number or “token” to the received card number that is unique for that card. The token is sent in a response back to the publisher 110 as the unique number to use in any communication subsequently between the publisher 110 and the gateway 102 to identify that card.

The gateway 102 checks the BIN consolidated tables 406 to determine which one or more debit networks 104, 106 the card participates in, and routes the card number to the appropriate network card registration platform(s), such as Registration and Matching Platform (RAMP)) 414. The RAMP 414 will generate a “token” for use in identifying the card number subsequently between itself and the gateway 102 and sends that token to the gateway. The RAMP 414 also sends the notice indicating whether the registration was successful or not. The RAMP 414 is either supplied by the debit network or utilizing a component of the present invention, a distributed platform designated as RAMP, as shown in the present example and described below. The RAMP 414 must store the card number in a manner that is compliant with all secure financial industry standards such as PCI. Card maintenance, such as subsequent deletions, is included as a part of the process.

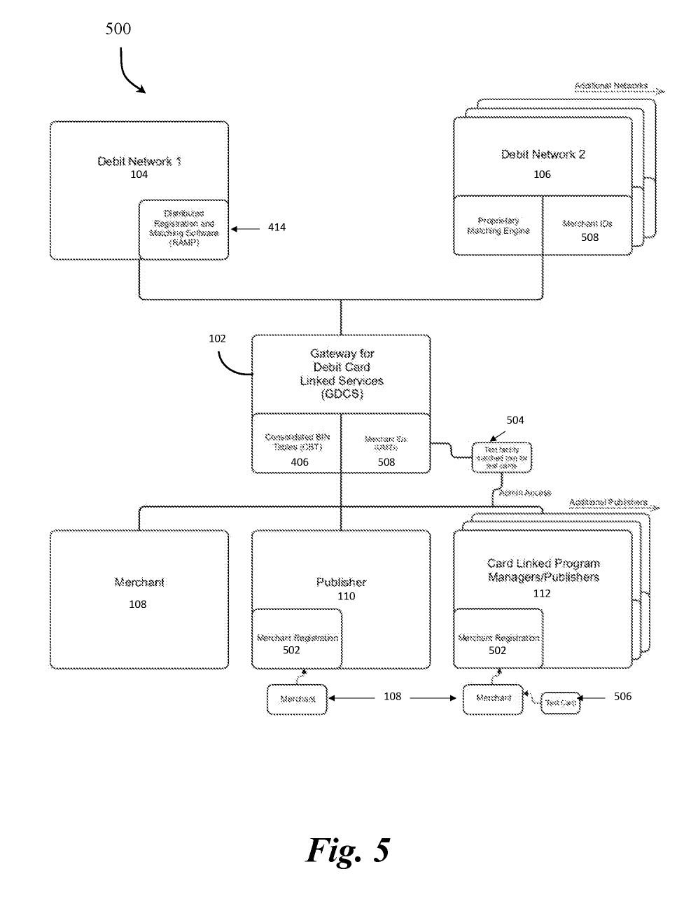

FIG. 5 depicts the flow of information and the system of components 500 involved in the registration of a merchant 108 associated with CLOs available to registered cards. This registration process includes both the general registering of the merchant 108 with the system but also information associating specific cards and/or groups of cards as eligible for a CLO at that merchant. The includes: Merchant registration and database management as well as merchant validation and testing.

To achieve this functionality, the system 500 of FIG. 5 further includes merchant registration functionality 502 and testing facility 504. The publisher 110 (as well as the program manager 112) provides merchant registration functionality 502 for the intake of information (e.g., name, location, etc.) for the merchant 108. The testing facility 504 provides the capability for publishers 110 (as well as program managers 112) to run test transactions at merchants 108 with pre-designated test debit cards 506 and receive detailed results showing exactly what data elements will be received by publishers 110 for transactions performed by eligible cards at that merchant 108.

### Merchant Registration and Database Management

The exemplary system 500 of FIG. 5 provides the facilities to allow publishers 110 (as well as merchant 108 and/or program managers 112) to register merchants 108 that will have CLO's associated with them for eligible cards using the merchant registration functionality 502. Publishers 110 call a gateway provided application programming interface (API) to send in the required individual merchant data (UMID) in order to register it on the platform. The merchant data received and stored in a database 508 includes data elements required to uniquely identify individual merchant throughout the US, including an Acquirer ID field and Merchant ID utilized in debit transaction purchase processing formats required by the debit networks.

In addition to registering the merchant information, publishers 110 must simultaneously with the registration, and/or as their program requires, provide the identification fields defined within the system processes for tying individual cards and/or groups of cards to the merchant location as eligible for a CLO. Cards are tied to merchants using identification fields within the card registration functionality 408 and merchant registration functionality 502 designated to indicate the relationship between the two.

The exemplary system 500 also provides for the maintenance of a shared common merchant database 508 that will be updated from multiple sources, including the publishers 110, program managers 112 and debit networks 104, 106, that will maintain the Acquirer Id and Merchant ID fields associated with a merchant name and address. This database 508 will be available for publishers 110, or program managers 112, to aid in their identification of the appropriate ID's to use when registering a new merchant 108.

### Merchant Validation Test Facility

In certain embodiments, the system 500 of FIG. 5 further includes a test facility 504 that provides functionality that allows publishers 110 to register test cards 506 that are deemed as eligible for all merchant locations, registered or not; the monitoring of transaction activity for these cards, assuming a match on any purchase transaction, and the storage of that transaction on a test transaction database. The test facility 504 also allows the test transaction database to be accessible to publishers 110 via an administrative website where a publisher 110 can view all transactions performed with their test cards. The data provided from these test transactions is typically utilized to aid in the establishing of the correct information with which to register a merchant. In certain embodiments, the test facility 504 can be implemented as part of the functionality of the gateway 102.

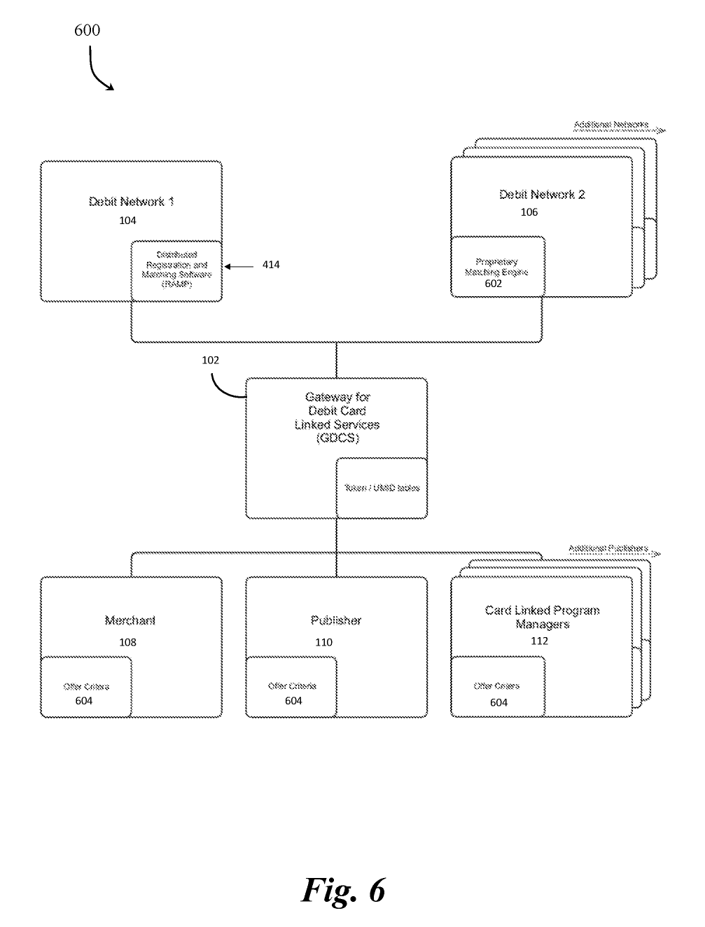

FIG. 6 depicts the flow of information and the system of components 600 involved to provide for: 1) the monitoring of purchase transaction data supplied by the debit networks 104, 106 to determine if a registered debit card has performed a purchase at a registered merchant 108 where that card has been deemed eligible for application of a CLO (qualification): and 2), the routing and transmission of the necessary data elements from that purchase transaction to the publisher 110 (or program manager 112) responsible for the qualifying CLO. The process includes transaction matching and qualified transaction delivery.

### Transaction Matching

The system 600 of FIG.6 provides for monitoring of debit purchase transactions occurring with registered cards at registered merchants 108 and for forwarding qualified or matched transactions to the appropriate publisher 110. Given the varying availability of resources at debit networks 104, 106 to develop the registration and matching functions themselves, two methods can be employed to match transactions.

In the first method, a debit network 106 provides a proprietary matching engine 602 for the registration and maintenance of card and merchant data routed to it from the gateway 102 as well as monitoring the purchase transactions for matches and forwarding any such qualified transactions to the gateway 102.

In the second method, software is made available to the debit network 104 by the gateway 102 providing a distributed processing architecture (RAMP 414) whereby the relevant registered cards and merchants for a particular debit network are stored and maintained by the provider of the gateway remotely on processing platforms managed by the debit network 104. The debit network 104 then makes available to the RAMP 414 all its purchase transactions in a standard format currently in use by the debit network 104. The RAMP 414 then performs the matching function and forwards only qualifying matched transactions to the gateway 102. The use of the RAMP 414 functionality enables the debit network 104 to avoid the development and maintenance required to support the registration of cards and merchant locations and the transaction matching logic.

### Qualifying Transaction Delivery

In the system 600 of FIG. 6 the gateway 102 is configured to determine for each matched transaction sent to it, either directly from a debit network or from the RAMP software module(s), which data elements should be transmitted (i.e., only purchase amount—cash back portions are excluded), which publisher should be notified of the qualified transaction, and routes the transaction to that publisher 110. Logic in the gateway 102 is configured to account for the possibility of multiple publishers 110, or program managers 112, having the same cardholder 410 and merchant 108 registered and providing notice to publishers 110, or program managers 112, via an indicator that a duplicate may exist. The publisher 110, or program manager 112, may then “score” or otherwise determine the appropriate rebate amount for the qualified transaction based on the offer criteria 604 for the card linked offer (CLO).

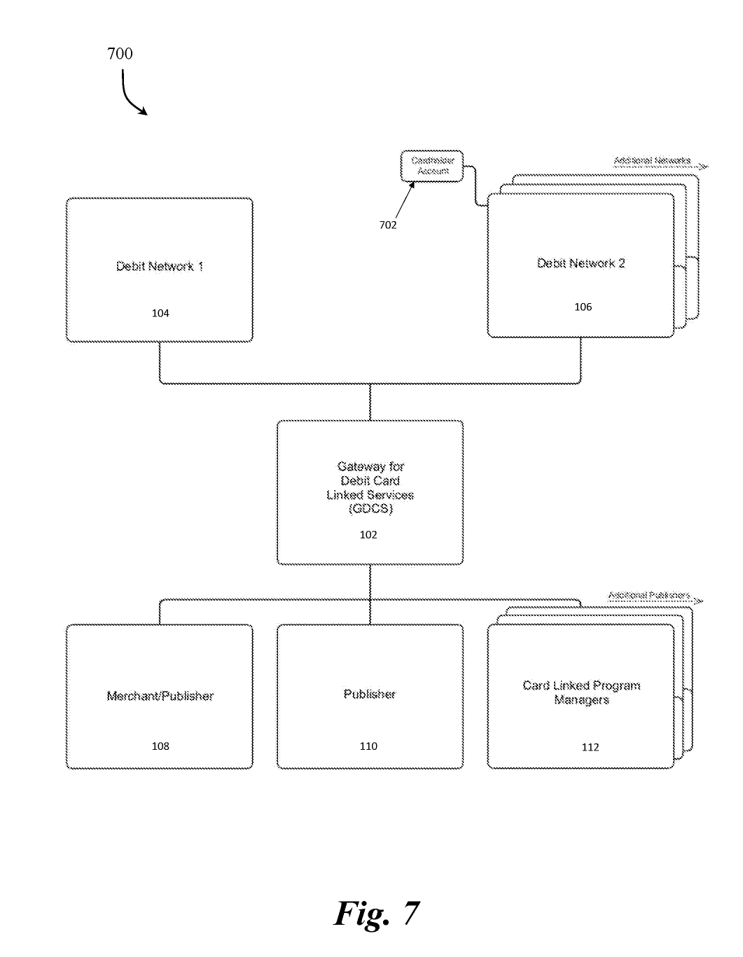

FIG. 7 depicts the flow of information and the system of components 700 involved to provide for the ability for a publisher 110, or program manager 112, to: submit a transaction (credit) in order to have funds transferred to a registered cardholders card account to complete the awarding of the value earned from a CLO. The system also provides for the routing and submission of such transaction to the appropriate debit network 104, 106 as well as the movement of funds associated with a credit transaction from the publisher 110 (or 112) to the debit network 104 (or 106). This process includes cardholder value settlement.

### Cardholder Value Settlement

The system 700 of FIG. 7 provides for a publisher 110, or program manager 112, to submit, via an application programming interface (API) provided by the gateway, a request to have a credit placed on to a card account 702. Generally this will be requested by a publisher 110, or program manager 112, in order to provide the monetary value earned from a qualifying card linked offer (CLO) to the cardholder 702. The data required in the submission from the publisher is sufficient for the gateway to transform the request into a standard credit transaction submission supported, in various formats, by each of the debit networks 104, 106. Thus, the actual monies provided to the cardholder are transferred from the publisher 110, or program manager 114, to the debit network 104, 106. It should be understood that wherever purchase transactions are referred to above, the invention likewise performs the same functions for returns, which are processed by merchants to reverse previous purchases, in whole or in part.

In certain embodiments, the reporting, billing, and support services associated with the processing described herein are also provided as part of the disclosed system and methodologies.

Thus, embodiments of the present invention provide interconnectivity for a number of US debit networks and a great variety of publisher entities in such a way as to allow each network and entity to have one standardized connection with the gateway. This is realized by having the gateway manage the nuances and differences of the various entities such that such differences are transparent to each entity. The manner in which such different environments are accounted for is the core of the invention's value to all entities involved, due to its' resultant simplification of the required development and ongoing maintenance involved with providing CLO-related services.

As utilized herein, the terms “comprises” and “comprising” are intended to be construed as being inclusive, not exclusive. As utilized herein, the terms “exemplary”, “example”, and “illustrative”, are intended to mean “serving as an example, instance, or illustration” and should not be construed as indicating, or not indicating, a preferred or advantageous configuration relative to other configurations. As utilized herein, the terms “about”, “generally”, and “approximately” are intended to cover variations that may existing in the upper and lower limits of the ranges of subjective or objective values, such as variations in properties, parameters, sizes, and dimensions. In one non-limiting example, the terms “about”, “generally”, and “approximately” mean at, or plus 10 percent or less, or minus 10 percent or less. In one non-limiting example, the terms “about”, “generally”, and “approximately” mean sufficiently close to be deemed by one of skill in the art in the relevant field to be included. As utilized herein, the term “substantially” refers to the complete or nearly complete extend or degree of an action, characteristic, property, state, structure, item, or result, as would be appreciated by one of skill in the art. For example, an object that is “substantially” circular would mean that the object is either completely a circle to mathematically determinable limits, or nearly a circle as would be recognized or understood by one of skill in the art. The exact allowable degree of deviation from absolute completeness may in some instances depend on the specific context. However, in general, the nearness of completion will be so as to have the same overall result as if absolute and total completion were achieved or obtained. The use of “substantially” is equally applicable when utilized in a negative connotation to refer to the complete or near complete lack of an action, characteristic, property, state, structure, item, or result, as would be appreciated by one of skill in the art.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification embodiments have been described in a way which enables a clear and concise specification to be written, but it is intended and will be appreciated that embodiments may be variously combined or separated without parting from the invention. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

What is claimed is:

1. A method of providing card linked services connected to debit card transactions, the method comprising;
registering, via a gateway, a debit card for participation in a card linked offer;
registering, via the gateway, a merchant for participation in a card linked offer;
matching, via the gateway, a transaction to a card linked offer; and
settling, via the gateway, the matched transaction based on the parameters of the card linked offer;
wherein the gateway provides a common interface between a merchant, a publisher of a card linked offer, and a debit network to facilitate the establishing and handling of a card linked offer involving a debit card transaction.

2. The method of claim 1, wherein registering a debit card for participation in a card linked offer comprises:
maintaining a consolidated file comprising BIN tables from one or more debit networks;
providing the consolidated file to a publisher of the card linked offer;
receiving a request for registration of a debit card number from the publisher;
providing the publisher with a unique token for identifying the debit card number in communications between gateway and publisher;
registering the debit card number with a registration platform of appropriate debit network based on the consolidated file; and
receiving, from the registration platform, a unique token for identifying the debit card number in communications between the gateway and debit network and indication of registration success.

3. The method of claim 2, wherein maintaining a consolidated file comprising BIN tables from one or more debit networks comprises filtering out entries for card numbers that are not eligible for participation in the card linked offer.

4. The method of claim 2, wherein the registration platform of the appropriate debit network comprises a distributed registration platform provided to the debit network and configured to interface with the gateway and debit network.

5. The method of claim 1, wherein registering a merchant for participation in a card linked offer comprises:
receiving merchant registration data including a unique acquirer identification and a unique merchant identification;
providing the merchant registration data to an appropriate debit network based on the received merchant registration data; and
maintaining a database of received merchant registration data.

6. The method of claim 5, wherein the received merchant registration data further includes an indication of one or more debit cards eligible for the card linked offer with the merchant.

7. The method of claim 5, wherein providing the merchant registration data to an appropriate debit network based on the received merchant registration data comprises: providing the merchant registration to a distributed registration platform provided to the debit network and configured to interface with the gateway and debit network.

8. The method of claim 5, further comprising:
providing a testing facility configured to:
register test cards for a card linked offer;
monitor and store transaction activity of registered test cards and store; and
provide publishers access to the stored transaction activity of registered test cards.

9. The method of claim 1, wherein matching a transaction for participation in a card linked offer comprises:
receiving, from a debit network, transaction details for a transaction that matches a card linked offer; and
providing data for the matched transaction to the appropriate publisher for the card linked offer for processing.

10. The method of claim 9, wherein the transaction details for a transaction that matches a card linked offer are received from a distributed matching platform provided to the debit network and configured to interface with the gateway and debit network.

11. The method of claim 9, wherein a transaction that matches a card linked offer comprises a transaction at a registered merchant using a registered debit card.

12. The method of claim 1, wherein settling the matched transaction based on the parameters of the card linked offer comprises:
receiving a credit request from the publisher of the card linked offer based on the matched transaction;
providing credit request details to the appropriate debit network;
collecting funds for the credit request from the publisher of the card linked offer; and
distributing collected funds to the appropriate debit network for refunding to the debit card used in the matched transaction.

13. The method of claim 12, wherein the funds collected for the credit request are collected by the publisher of the card linked offer from a registered merchant involved in the matched transaction.

14. The method of claim 12, wherein the credit request details are provided in a credit submission format of the appropriate debit network.

15. A system for providing card linked services connected to debit card transactions, the system comprising:
a gateway configured to provide a common interface between a merchant, a publisher of a card linked offer, and a debit network to facilitate the establishing and handling of a card linked offer involving a debit card transaction, the gateway operable to:
register a debit card for participation in a card linked offer;
register a merchant for participation in a card linked offer;
match a transaction to a card linked offer; and
settle the matched transaction based on the parameters of the card linked offer.
